(19) United States
(12) Patent Application Publication
(10) Pub. No.: US 2011/0284516 A1
(43) Pub. Date: Nov. 24, 2011

(54) Modular heating and lighting system for the construction of lighting and heating elements

(75) Inventor: Jiri Burda, Friedrichsdorf (DE)

(73) Assignee: Burda Worldwide Technologies GMBH

(21) Appl. No.: 13/141,147

(22) PCT Filed: Dec. 22, 2009
(86) PCT No.: PCT/EP09/67731

§ 371 Date: Aug. 9, 2011

(30) Foreign Application Priority Data
Dec. 23, 2008 (DE) 10 2008 055 585.1

(51) Int. Cl. H05B 1/00

(52) U.S. Cl. 219/220

(57) ABSTRACT

The invention relates to a modular heating and lighting system for the construction of lighting and heating elements. Existing systems require rigid planning and a fixed construction or determine that loose wiring must be used. The invention should avoid this and offer a fixed, yet multifunctional system which can be constructed from standard components. This is achieved according to the invention in that module rows with different function modules are used, which are connected via a supply connection to a module connection on the building side. Starting from here, at least one module row extends by means of a supply assembly, which has the supply lines for supplying all function modules provided in the module row, which lines are parallel to one another, wherein the supply assembly has output interfaces for connecting the function modules.

The invention relates to a modular heating and lighting system with at least one module row which is formed by at least two function modules arranged one behind the other in a row and with a different function from one another. The function modules in this case comprise at least two types of function modules mentioned in the following type list:
heating modules with at least one heat-emitting heat radiator,
lighting modules with at least one light-emitting lighting element,
sound system modules with at least one loud speaker,
display modules with at least one backlit information surface or
multifunction modules with a combination of individual or all functions of the remaining function modules.

The module row has a central supply connection, via which the function modules are fed with the inputs necessary for their function via supply lines.

A modular heating and lighting system for the construction of multifunctional lighting and heating elements of this type is known from EP 1 530 404 A2. In the case of the known device, light sources in the form of built-in halogen spotlights are arranged on both sides of a heat radiator emitting infra-red radiation. The infra-red radiator is here provided in a separate housing, whilst the two light sources are accommodated in separate housings which are connected to the radiator housing via joints. In this manner, the radiation direction of the light can be varied compared to the propagation direction of the heat radiation.

With the known combination radiators, both heat radiation and light radiation can be emitted very well for example in a tent or under a pavilion roof. A certain disadvantage consists however in the fact that, in the case of larger installations, a plurality of devices must be installed independently of one another which requires external wiring in particular. Further, of course only the device as is offered as a single part can be installed. This is detrimental to flexibility, as not every user would like light and heat sources mounted at a predetermined distance from one another and furthermore not every user has to rely on providing a light source next to the heat source for example.

In addition to overcoming the above-mentioned limitations of the functionality, there is further the necessity of optically and functionally increasing the attractiveness of light/heat sources in order to develop new areas of application and therefore also customers in this manner.

It is therefore the object of the invention to construct the existing modular heating and lighting system in a more flexible manner and extend it so that, if required, further functions can be added.

This object is achieved according to the invention in that the supply connection is connected to a module connection and a supply assembly extends along the module row, which has the supply lines for supplying all function modules provided in the module row, which lines are parallel to one another, the supply assembly having output interfaces for connecting the function modules.

One of the basic ideas of the present invention is the fact that a modular system is constructed, in which individual function modules are used, which can be used in any desired sequence one behind the other or also next to one another. These function modules can be the most various of modules, particularly the above-mentioned individual modules. The invention is however not limited to the use of these individual modules, it can also be used with other modules, even if the above-mentioned modules would not be used in the process, but particularly in combination with the above-mentioned type series.

The invention can be used both indoors and outdoors. Further, it can be used both for private users and for industrial and commercial users.

In the simplest case, a module according to the invention has precisely one function. This is a heating module, a lighting module, a loud-speaker module or a display module through to a module exchange which is able to transmit moving images. All of these individual functions can be offered in separate modules, but it is also possible and is also in practice advantageous if an individual module has a plurality of functions which can be integrated in a common housing or also can be realised by means of a housing composite, so that each module, as is known from the above-mentioned prior art, has a plurality of part housings which can be connected to one another in a fixed or an articulated manner.

A further basic idea of the invention consists in the fact that the individual modules are not supplied separately from one another, but rather that a supply assembly is constructed, which allows the connection of all modules in supply lines which run parallel to one another and feed the individual modules with necessary information and media. Thus, all modules of the system can be connected in series one behind the other. The supply assembly is in turn connected to a supply connection, by means of which the function modules, connected in series or possibly also parallel to one another, can be connected to a local installation of a module connection.

To construct a modular, multifunctional system, it is therefore merely necessary that the module connection be provided on the side of the building or the side of the site. This module connection has all supply lines which require the supply assembly in order to supply the individual function modules with their required input variable. Module connection and supply connection can also be fixedly connected to one another, for example in the context of a fixedly soldered or wired installation.

Preferably, however, the individual function modules and also the supply assembly with the module connection are connected to one another via suitable releasable plug connections. Thus, for example, a lighting module and a heating module require a current connection and, depending on the required heating output, for the most part additionally also a three-phase current connection for supplying the heat radiator, which is the case in particular for a plurality of heat radiators connected one behind the other. A module having one or a plurality of loud speakers by contrast requires a low voltage connection, via which the loud speaker signal can be transmitted. The same is true for television modules or telecommunications modules, which are described comprehensively in the following.

Another module variant in turn requires a water or gas installation. So, for example in warmer areas, the type list of the function modules can also comprise modules which emit water in the form of fine droplets or a mist, so that a cooling action occurs below the function module due to the air energy removed as a consequence of the enthalpy of evaporation. Such devices are essentially known from southern countries, but not in connection with a separately connectable function module, but rather as a permanently installed plant. A function module of this type would either have to have a water connection so that water supplied via fresh water access is atomised in the module itself.

Alternatively, and naturally in a substantially more simple manner for the construction of the module, the atomised water can be supplied in a manner already ready for spraying via the supply assembly. A module of this type can naturally be constructed in a much more compact and simple manner, which is preferred for optical reasons and cost reasons. Further, no pressurised water is conveyed through the supply assembly, which in turn simplifies the same and reduces the risk of an undesired escape of water.

Modules of this type can also be used in the entertainment sector, in order for example to conduct mist as an effect onto the dance floor in a discotheque or on an open area.

As long as modules of this type are accommodated in the type catalogue, the supply assembly has a line which transports a liquid or a vapour. The supply connection and the module connection are then preferably provided with corresponding connections of the water installation, particularly the known valve connections. The module connection and also the supply connection for connecting the supply assembly to the module connection can be constructed in one piece, so that all of the supply lines can be connected with one single plugging procedure.

Simpler and in particular more functional to configure by contrast is a technology in which module connection and supply connection have separate plug connections, so that they can be connected to one another independently of one another. Although this leads to a certain installation risk, as it will possibly be forgotten to fix one of the individual connections, it leads to higher functionality, as even if the supply assembly has all forms of supply lines, on the building side or the site side, the module connection does not have to have all connection lines as long as certain module types are not desired by the user. Further, the module connection can in this manner be present in the form of bundled individual connections which can be produced simply and inexpensively.

A particularly attractive property of the module system is the fact that the function modules can be combined and connected with one another in a branched manner with straight or curved course, in the manner of a network, in an annular manner or star-shaped manner. In this case, “dummies”, that is to say functionless modules with forwarding of the supply assembly, can extend the individual sections. In this manner, the course of the sections formed by the modules can be adapted practically completely to the purpose.

So, a ring of curved functional modules can be arranged for example under a round shade, such as a large shade of an open air bar, which ring is either fed directly, has [lacuna] as the supply connection, or has one or more branches running inwardly towards the shade centre, which extend outwardly under the shade in the manner of spokes, one of these branches then forming the supply branch, that is to say is connected in the centre to the module connection, whilst at the opposite end, the supply assembly continues from this branch into the ring.

Terrace roofs, tents, house walls and the like can also be provided with a row of function modules in a perfectly fitting manner, so that a very high quality optical impression results at the same time as optimal utilisation of the space. To this end, a spectrum of very different housing lengths on the one hand and tailored manufacturing on the other hand can be offered. The latter can be offered comparatively simply, as the housing is constructed in a tubular manner and no function elements are provided at the housing ends in a region to be cut to length. Thus, the housing can simply be shortened to the required length, it being possible to dimension the region to be cut to length in such a manner that the allowed maximum shortening is so large that the next shortest housing shape in the product spectrum adjoins it.

The functionality is increased further if either the housing of the function modules or the above-mentioned dummies, insofar as these are used, or interposed spacers are used, which in each case have an extendible housing or a housing which can be shortened by means of spacers which can be screwed in or removed from the side.

The supply assembly is provided with individual output interfaces, using which the function modules can be coupled to the supply assembly. Two preferred configurations come into consideration for implementing this technology:

In a first configuration, the supply assembly extends parallel to the function modules, so that the function modules can be connected, for example at the rear of their housing, to the supply assembly via a connection interface arranged there.

In this configuration, a rail system can for example be used as support for the function modules, which rail system has the supply assembly internally or externally. One possible configuration of such a rail system is for example a flat channel which is constructed in the form of hollow profiles with round or rectangular cross section and has the supply lines on the inside, the rail system having the connection interfaces which can be connected at the side.

The individual function modules can then either be plugged directly into the output interfaces using their connection interfaces which are protuberant in the manner of plugs for example, or can also be connected via a rigid or flexible intermediate line which runs from the connection interface to the output interface. Depending on the requirement, either the direct plugging in can already effect the fixing of the function module, so that no additional fixing means are required. In this case, the plug connection can be configured in such a manner that a secure hold is possible.

Finally, the connection interface or the supply interface also does not have to be constructed integrally, rather it is possible that various part interfaces are provided at a distance from one another for example, so that a two-point or multi-point mounting can be constructed in particular in the case of a socket connection between the connection interface and output interface, which are then of course likewise arranged at a corresponding distance from one another on the rail system. The rail system itself preferably consists of individual modules which essentially have the length of a function module or a larger length. Connections are then provided at the ends of the rail system, so that following plugging together or by means of plugging together of the individual modules of the rail system, the supply assembly is closed between the two adjoining rail system modules.

Alternatively to a direct fixing of the individual function modules on the rail system, either via the above-described plug connection or via a separate fixing mechanism, a mounting support can also be provided between the housing of the function module and the rail system, by means of which the housing of the function module can be connected to the rail system in a fixed or articulated manner. Such an articulated connection can be equipped in a very wide range of manners, thus, for example, the mounting support can be constructed in a U-shaped manner, so that the housing of the function module can be held between two articulation points in a rotatable, or depending on the anchorage point, also in a pivotable manner on the mounting support.

An alternative type of mounting is provided by the fixing option of a longitudinal housing of the function module on an end face, so that the function module protrudes from the rail system at right angles or at any other angle. Here, a rotatable or pivotable linking, which enables for the most part any orientation of the function module, can be achieved in particular via a ball fixing. In the case of a ball joint of this type, a flexible hose element must of course be provided between the output interface and the connection interface, so that the movability of the function module is ensured in the required directions. Naturally, corresponding joints can also be provided within a line between the connection interface and the output interface, it would also be possible, with corresponding outlay to produce the flexibility in the input region.

Of course, instead of the above-described rail system, any further form of a module row support can be provided, it being possible for this module row support to even be formed by brickwork or a similar supporting structure which is already present from the side of the building and extends in the longitudinal direction of the module row. The module row support can also be formed by a strut frame which has vertical struts, it being possible for the function modules to be arranged between the struts or alternatively for further module supports to be provided between the struts.

Here, the configuration possibilities depend in addition to the financial requirements on the on-site pre-installation, the supply assembly having to extend along the module row. However, this does not necessarily require that the supply assembly connects each individual module directly to one another, rather, for example in the case of vertical struts, the supply assembly can also be arranged in the region of the floor, the supply assembly then being guided upwards using an upwardly directed branch or also in a looped manner on the strut, in order to supply the function module fixed there.

A further very beneficial configuration of the invention uses the function for the module itself, in order to construct the supply assembly. In this configuration, each function module is provided with a housing or has a supply assembly section on its reverse, the function modules having attachment regions at which adjacent function modules or also functionless spacers are arranged.

In this configuration, each function module has a section of the supply assembly, the supply assembly section being correspondingly extended in the case of connection of connection interfaces of the function modules to one another. The functionless spacers in this case likewise have a section of the supply assembly, so that the spacing of the function elements from one another can be extended using these spacer elements without interrupting the supply assembly.

The above-described configuration has the particular advantage that a module row, which possesses the desired combination of the individual functions, can be constructed independently of the local occurrences by light plugging together of the function elements. By using spacer elements or different module elements, which can for example also have functionless housing sections, the customer's wishes can therefore be taken into account to a large extent.

The construction of an additional module row support is only additionally necessary for reasons of mechanical rigidity, as long as a corresponding installation should not be found on site. It is however no longer necessary to construct the supply assembly externally. Here, a module connection only has to be provided at the start of the module row, to which module connection the first function element or a spacer can then be connected, the connection interface of this first module element then functioning as the supply connection for the entire module row.

A further feature of this configuration is the fact that the supply assembly has all supply lines which are required for feeding all of the module elements within the module row, even if the individual function element through which the corresponding segment of the supply assembly passes should not have this function itself. Thus, all of the functions provided by the module row can be tapped at any point of the module row.

It is not just a straight module row which can be built by means of the construction technology of the module system according to the invention. Rather, a regular rail and grid network can be constructed, whereby crossing or branching modules with or without function can be provided here, which divide supply lines of the supply assembly to a plurality of branches.

So, a grid structure with rectangular honeycomb can for example be constructed from the function elements for supplying a region of an outdoor restaurant, it being possible for the desired number and functionality of the function modules to be provided between the individual crossing points in each case. Neither the function elements nor the crossing or branching elements have to be straight, even curved elements or even elements which can be bent due to their elasticity are possible. Finally, it is possible that the function modules can be extended in terms of their length, for example by means of the function of a telescopic rod.

Using the multifunctional heating and lighting system according to the invention, a larger area can now be equipped in an optically attractive manner and with a premium quality impression. So, for example, a beer garden can be provided with heating elements and heat in the region of the tables by means of heat radiation. These heating elements are preferably infra-red radiators, gas radiators could also be considered due to the multifunctionality of the supply assembly, however. The use of the infra-red radiators has a great advantage here for reasons of safety, however, as the escape of gas and unintentional combustion in the event of electrical feeding of the heat radiator can be prevented.

In addition to lighting the beer garden and heating the sitting and standing areas, a further function, can be realised for example for financing the system for the operator. In a simple case, this can be a backlit area in the context of a function module, which provides the advertising, for example of a brewery. Alternatively or additionally, a display of scrolling text can also take place, in order for example to indicate special offers or current events or sporting events. Small video modules can also be provided so that additional information can be displayed using them.

A further advantageous configuration of the invention provides switches, by means of which the individual function elements can be controlled. In the simplest case, these can be normal changeover switches which are operated manually. These switches can either only switch off the function of an individual function element or also interrupt the supply assembly completely, so that the entire region of the module row behind the switch can be deactivated.

Instead of a normal selector switch, a switch which can be controlled remotely via radio remote control or in another manner can also be used. The supply assembly can also have a control line, or a control line can be laid separately parallel to the supply assembly, which addresses the switch. In this manner, each individual function module or a row of function modules can be activated or deactivated via a central operating position. The output of the function element can be manipulated both via this switch and via the conventional or remotely-operated switch, for example in order to reduce the heat or light radiation or to vary the output power of a sprayer of a cooling medium. Scrolling texts or advertisements can in this manner further be switched from a night- to a day-mode. The latter can however also take place automatically via a brightness sensor which can be integrated into the function module.

In the region of a restaurant especially, it is also advantageous for such applications however, if automatic detectors are arranged within the module row, which influence the function of the function modules. These detectors can for example be movement detectors or heat detectors which detect the presence of people, so that the heating output is only switched on in a targeted manner where people are actually staying.

The detector can have influence on individual functions or also on the function module as a whole, so that the function module is either only switched off to a certain extent or is completely deactivated. So, for example, it may be expedient in the region of the restaurant if the function module maintains the lighting and by contrast switches off the expensive heat radiation. In this manner, the impression of a comfortable, attractive beer garden is created without expensive heat energy having to be used for regions which are not in use.

A further configuration of the invention uses function modules which enable an interaction between the people located in the vicinity of the function module and a controller. So, it may for example be that the supply assembly also has a telecommunications line, via which the guest at a beer garden can for example contact the personnel. Here, either a telephone receiver can be provided on the function module or an intercom with loud speaker and microphone can also be arranged in the region of the function module.

Also, all other signal types, for example Internet access or access to a local computer network can be realised via the function module and the corresponding expansion of the supply assembly. The individual function modules in this case do not have to have a certain form, but rather function module should be understood as meaning any module which can be connected via a connection interface to the output interface of the supply assembly. So, for example, lighting elements can be integrated in a housing, whilst on the other hand conventional lamps can also protrude or hang down from the housing via connection rods or the like. Here, no limits are placed on the designer's diversity of design.

A further application of the invention consists in using the function modules in order for example to display escape directions or also other directions. So, for example, the system according to the invention can also be used for signage, for example within an exhibition hall and at the same time provide the stands with corresponding supply lines.

In all configurations, function modules can be provided, which enable pure tapping of the individual parts of the supply assembly, for example in order to connect further elements hereto. So, for example, the supply assembly can also comprise a water line which enables the tapping of a fresh water supply, for example at the exhibition stand. Also, pure sockets or the like can be realised in this manner.

Finally, it can be possible that the individual module rows are interrupted over relatively long paths, the supply assembly then being routed via a flexible line from a first module row section to a second module row section. One use possibility for such a configuration is a Christmas market for example, in which adjacent function modules are arranged within the individual housing, whilst a flexible bridging hose closes the supply assembly between the housings.

Finally, the above-described control line or also the supply assembly can have an addressing system, via which individual switches of the function elements for example can be addressed. The addressing can here essentially take place in accordance with the technologies of networking technology, particularly can here obey the TCP/IP protocol. Here, the function element must of course have a small inherent logic which can be addressed via the addressing system, so that an individual switch or a plurality of individual switches can be addressed. Corresponding electrical switches, particularly relay switches then enable the switching of consumers who call for higher outputs.

The previously described embodiments only constitute use examples of the basic idea according to the invention, that multifunctional function modules are used in order to equip a larger area with functions together with a supply assembly from which all necessary signals can be tapped. The supply assembly is here either held in such a manner that only the functions desired in the system are possible or it also has all functions so that parts of the supply assembly are not then required if only some functions are integrated into the modules.

Further features and advantages of the invention result from the sub-claims and from the following description of preferred exemplary embodiments on the basis of the drawings.

In the drawings:

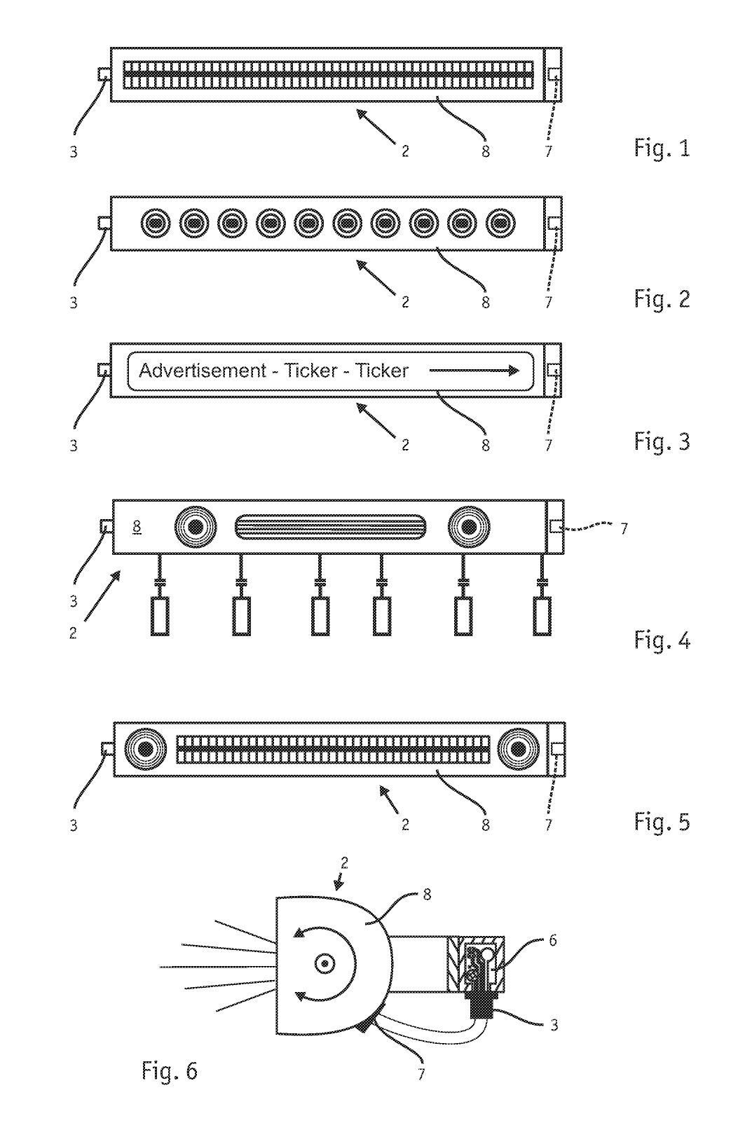

FIG. 1 shows a first configuration of a function module,

FIG. 2 shows a second configuration of a function module,

FIG. 3 shows a third configuration of a function module,

FIG. 4 shows a fourth configuration of a function module,

FIG. 5 shows a fifth configuration of a function module,

FIG. 6 shows a function module with a module row support in a side view in section,

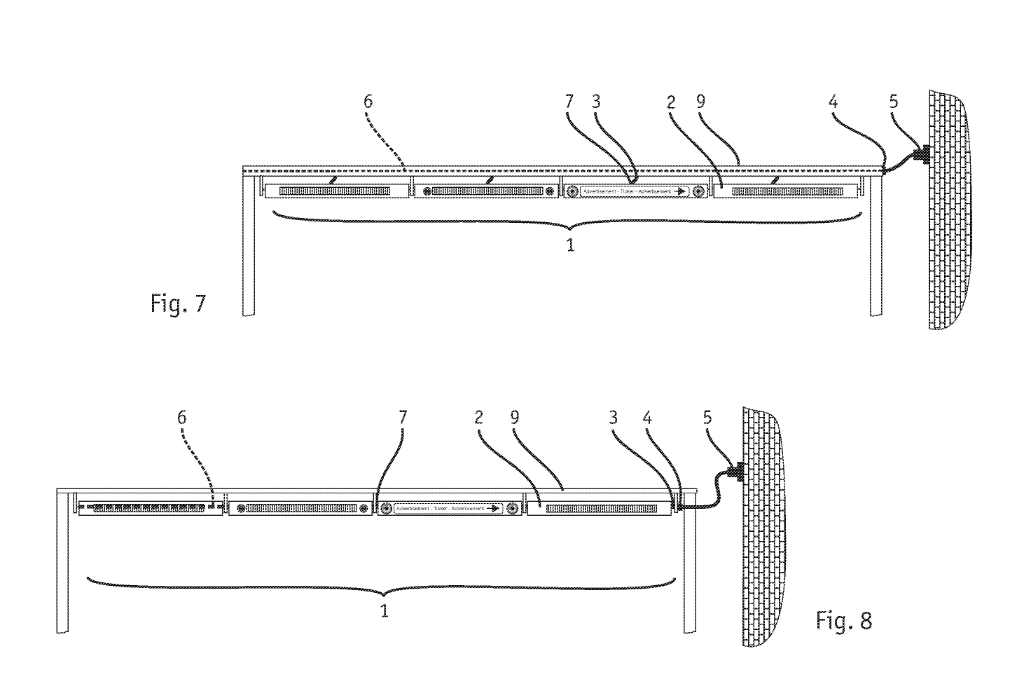

FIG. 7 shows a first configuration of a module row,

FIG. 8 shows a second configuration of a module row and

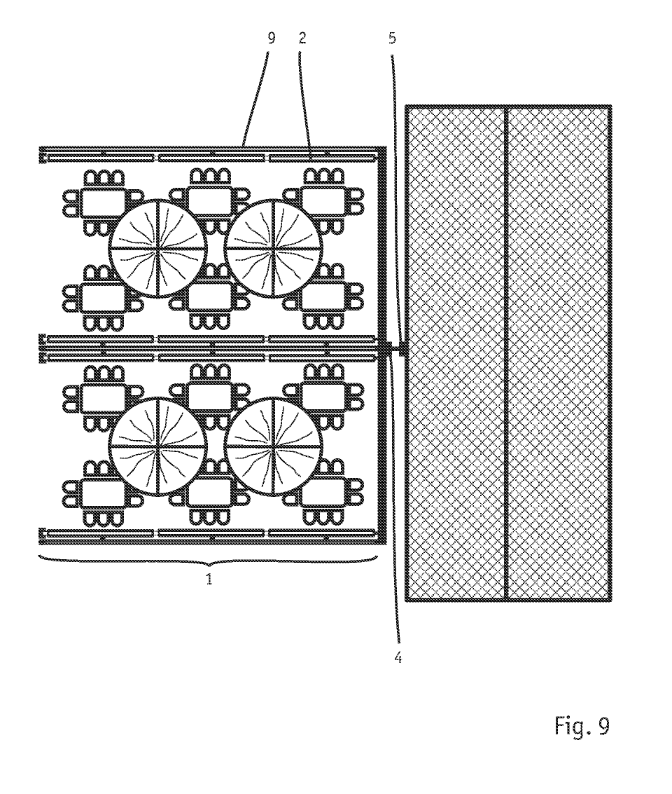

FIG. 9 shows an exemplary construction with the module system according to the invention.

In the FIGS. 1 to 5, exemplary function modules 2 are indicated which could be used in connection with the present invention without the invention being limited to the shown exemplary embodiments.

FIG. 1 shows a heating element which has a housing 8, in which a heat radiator is arranged behind a protective grille. This construction essentially corresponds to the construction of the known heat radiators. The housing which is preferably produced from a high-quality material such as aluminium or high-grade steel for example is elongated and preferably has a connection interface 7 and an output interface 3 at both of its end-face ends.

In the case of the embodiment of the function module 2 illustrated here, the supply assembly 6 (not shown here) is integrated into the housing 8 of the function module 2, that is to say, the connection interface and the output interface 3 are constituents of the housing 8. As a result, the function modules 2 can be plugged together simply and easily. As the supply assembly is already elongated or closed by means of the plugging together of the function modules 2, each function module 2 can therefore supply the following function module(s) with the in-feeds necessary for their function, even if one of the forward function modules 2 within the module row 1 has another or, in the extreme case, even no function whatsoever.

Connection interface 7 and output interface 3 are only shown schematically in the FIGS. 1 to 5. In the majority of use cases, the two interfaces have a plurality of plug/socket pairings arranged in parallel, which contact the individual supply lines of the supply assembly 6 in each case individually or in a bundled manner. As long as these lines are electric cables, all plug connections from electrical engineering come into consideration. As long as the supply assembly 6 also comprises water- or vapour-conveying lines, the plug valves known from laboratory technology, which automatically open when socket and plug are plugged together and automatically close when detached, come into consideration here. Naturally, all other types of connections are also possible, including the conventional screw connections from water plumbing installation technology.

The function elements 2 shown here can be plugged together to form a module row 1 or a network of such module rows 1 and could then be mounted such that they hang freely between two or more fixing points as long as the housing 8 is constructed in a correspondingly flexurally rigid manner. Alternatively, suspension on an upper support structure as module row carrier 9 comes into consideration. A support construction, on which the function elements are fixed, can also be provided in the region of the module row 1. This can for example be a rod framework or similar.

In FIG. 2, a function element 2 is illustrated which has built-in halogen spot lights exclusively for lighting purposes. In FIG. 3 in turn, a function element 2 is illustrated which can be used as a display means. Here, a display is provided along the housing 8, which is able to display scrolling text. The data for displaying the information stream can either be transmitted as a video signal via a data bus integrated into the supply assembly 6 or also be saved in the function module 2 which can have data storage means for this purpose. This can be present in the form of an insertable SD card or another data storage means.

The scrolling text displayed can be used for example for informing guests about current events. Here, the content of an RSS stream can be displayed for example, for example with the current results of sporting events. Also, permanently stored advertisements or the displaying of special offers or events information is possible, so that this function module can increase the attractiveness of the module system in many ways. As long as the video signals are created elsewhere and are present at the module connection 5 for connecting the module row, a data bus, which can run parallel to the supply assembly 6 or which can be integrated into the supply assembly 6, can be used for transmitting the scrolling text.

In the FIGS. 4 and 5, two further configurations of function modules 2, which are constructed multifunctionally, are shown. The function module 2 illustrated in FIG. 4 has one loud speaker in each case at the side on both end regions and an air vent for atomised water inbetween. Lamps (the cable lengths are illustrated shortened here), which ensure atmospheric lighting, hang down from the underside of the housing 8. In FIG. 5, a further combination is illustrated. Here, two loud speakers were combined with a heat radiator. All function modules illustrated only constitute exemplary embodiments, all others and also combinations with functions not listed are possible.

In FIG. 6, the function module 2 from FIG. 1 is shown illustrated in a side view in section. Here, the supply assembly 6 is illustrated schematically in section, which supply assembly here has a water supply line (right top), two electrical cables (left top) and a 4-core three-phase current cable (left bottom) for supplying the heat radiator. Although the function element 2 only has one heating element, all cables for functions of other function elements 2 are contained in the supply assembly 6, so that the remaining function elements 2, for example those illustrated in the FIGS. 2 to 4, can be connected to the supply assembly 6.

The supply assembly 6 is connected to the output interface 3. This output interface 3 is used for connection to a connection interface 7 of the respective function element 2. If talk in made in this context of “one” output interface 3, this does not mean that all supply lines of the supply assembly 6 have to be connected via a [lacuna] in a housing or via a plug/socket combination. The connection interface 3 like the output interface 7 also can rather also distribute itself over a plurality of part interfaces spatially separated from one another.

An important aspect of an embodiment of the invention is the fact that the housing 8 has a certain length, the module row carrier 9 and the output interface being arranged in such a manner that the connection interface 7 and the output interface 3 are connectable to one another directly by means of plugging together or via an intermediate cable. To this end, as long as it is connected to the supply assembly via a cable integrated in the module row carrier or also an external cable, the output interface 3 can also be arranged in a movable manner on the module row carrier.

In the exemplary embodiment shown, a cable runs from the output interface 3 to the connection interface 7. As here the function module only has one function, although all internal cables are routed from the supply assembly 6 to the output interface 3, the interface for the 4-core connection cable of the heat radiator is connected there, which cannot be seen here. To this end, the output interface 3 is constructed in such a manner that the plugged in plug of the cable only produces the connection to this cable, but for example, the water supply system illustrated top right remains closed. It is here realised by means of a spring-loaded closure device which cannot be seen here and closes the output of this water supply when it is inactive.

Two different configurations of the module system are illustrated in the FIGS. 7 and 8. FIG. 7 shows a system in which four function modules 2 are arranged below a module row carrier 9, which function modules are pivotably connected to the module row carrier 9 by means of a mounting aid. Here, the supply assembly 6 runs through the upper carrier of the module row carrier 9 which extends over the entire length of the module row 1 and has a supply connection 4 connected to the supply assembly 6 at its left end. Via this supply connection 4, the supply assembly 6 is connected to a house-side module connection 5. This connection couples all necessary signals and media for supplying the individual function modules 2 in the supply assembly 6, the connection to the connection interface 7 in turn being produced via the output interface 3. Thus, the module row carrier 9 and the supply assembly 6 are constructed in such a manner that the spacings of the output interfaces 3 corresponds to the length of the function modules, this not being required. Likewise, a longer distance could be realised via cable, line or slide connections.

FIG. 8 shows a modification in which the supply assembly is not arranged in the upper carrier of the module row carrier 9, but rather passes through the housing 8 of the function modules 2. Here, the ends of the function modules 2 are therefore connected on the right to the output interface 3 and on the left to the connection interface 7 (or vice versa). Naturally, the housing 8 of the function modules 2 also does not have to be straight and elongated in this configuration, but rather can take up any desired form.

FIG. 9 finally shows a beer garden as a use example, which is equipped with the module system according to the invention. Here, starting from the pubic house indicated on the right, three module rows 1 extend at right angles into the open area, the upper and the lower module row 1 in each case being equipped on one side in each case with three function modules 2 which are illustrated in FIG. 7 and connected to a module row carrier 9. In the central region, the module row carrier 9 has two rows of function modules 2 which radiate to both sides of the module row carrier 9.

The embodiment shown in FIG. 9 is only one of the countless combinations of the function modules 2 according to the invention. The particular advantage of this type of supplying of a region with different modules consists in the fact that in this manner an optically appealing, very functional and reliable supplying of the area with heat energy, light and/or other media can be achieved. Part of the function modules or also only parts of the functions of a module can further be switched off automatically or manually via partial switchings off, in order to avoid any unnecessary energy costs or to reduce the noise level in a beer garden.

### REFERENCE LIST

1 Module row
2 Function module
3 Output interface
4 Supply connection
5 Module connection
6 Supply assembly
7 Connection interface
8 Housing
9 Module row carrier

1. Modular heating and lighting system with at least one module row which is formed by at least two function modules arranged one behind the other in a row and with a different function from one another, wherein the function modules are selected from the following type list:
heating modules with at least one heat-emitting heat radiator,
lighting modules with at least one light-emitting lighting element,
sound system modules with at least one loud speaker,
display modules with at least one backlit information surface or
multifunction modules with a combination of individual or all functions of the remaining function modules, and
wherein the module row has a central supply connection, and starting from this supply connection, the function modules are fed with the inputs necessary for their function via supply lines, wherein
the supply connection is connected to a module connection and a supply assembly extends along the module row, which has the supply lines for supplying all function modules provided in the module row, which lines are parallel to one another, wherein the supply assembly has output interfaces for connecting the function modules.

2. Modular heating and lighting system for the construction of lighting and heating elements according to claim 1, wherein each output interface enables a connection to all supply lines of the supply assembly, so that every type of the function modules can be connected to every output interface.

3. Modular heating and lighting system for the construction of lighting and heating elements according to claim 1, wherein the output interfaces have a part interface, arranged next to or above one another, for the connection of the different types of function modules, wherein the function modules in each case have one connection interface which can be plugged into the part interface.

4. Modular heating and lighting system for the construction of lighting and heating elements according to claim 3, wherein the function modules have a housing, wherein the housing can be connected in a rotationally fixed or articulated manner directly or via a mounting support to a wall or a module row carrier.

5. Modular heating and lighting system for the construction of lighting and heating elements according to claim 1, wherein the function modules of a module row are connected one behind the other at least in sections and the supply assembly extends through the function modules, wherein the function modules have a connection interface and an output interface and independently of the type of the function module, all supply lines are looped through the function module from the connection interface to the output interface.

6. Modular heating and lighting system for the construction of lighting and heating elements according to claim 4, wherein the housing of the function modules has connecting means, formed by plugs and sockets in particular, via which the housing of adjacent function modules can be plugged together.

7. Modular heating and lighting system for the construction of lighting and heating elements according to claim 6, wherein the connection interfaces and the output interfaces are constructed as a plug/socket pairing, wherein the plug/socket pairing is constructed in such a manner that in the case of the plugging together of two function modules, the respective connection interface and the adjacent output interface are connected.

8. Modular heating and lighting system for the construction of lighting and heating elements according to claim 7, wherein the connection means are formed by the plug/socket pairing.

9. Modular heating and lighting system for the construction of lighting and heating elements according to claim 5, wherein the module row has at least two function modules, the connection interface and output interface of which are connected to one another via an additional, in particular flexible bridging line.

10. Modular heating and lighting system for the construction of lighting and heating elements according to claim 1, wherein the type list from which the function modules are selected additionally comprises the function modules
water module with at least one water-spraying device and/or
atomising modules with at least one spraying element emitting atomised water and/or
video playback modules with a display for displaying images and/or for playing films or scrolling text and/or
recording modules with at least one device for recording image, film or sound signals.

11. Modular heating and lighting system for the construction of lighting and heating elements according to claim 1, wherein the function modules have a switch at least to some extent, by means of which the function of the function module can be switched off without interrupting the supply assembly.

12. Modular heating and lighting system for the construction of lighting and heating elements according to claim 11, wherein the switch is a movement detector, a heat detector or a switch remotely switchable by remote control.

13. Modular heating and lighting system for the construction of lighting and heating elements according to claim 12, wherein the supply assembly has a control line which interacts with the switch via an addressing system developed in particular via the TCP/IP network protocol, wherein an external control is provided, which is able to address and to activate or to deactivate the switch via the control line and the addressing system.

14. Modular heating and lighting system for the construction of lighting and heating elements according to claim 1, wherein additional straight or curved passive spacers are provided, which can be connected between two or more function elements and in each case have a connection interface and at least one output interface for looping through the supply assembly.

15. Modular heating and lighting system for the construction of lighting and heating elements according to claim 1, wherein, for forming a functional branch, at least one function element has two or more output interfaces for the connection of further module rows or individual function elements, wherein the supply assembly is divided in the branch into individual branches and all inputs provided by the supply assembly can be tapped at every output interface.

16. Modular heating and lighting system for the construction of lighting and heating elements according to claim 1, wherein the function elements can be changed in terms of length.

17. Modular heating and lighting system for the construction of lighting and heating elements according to claim 1, wherein the passive spacers can be changed in terms of length.
